(19) United States
(12) Patent Application Publication
(10) Pub. No.: US 2002/0174641 A1
(43) Pub. Date: Nov. 28, 2002

(54) Ergonomic garden implement

(76) Inventor: Blyth S. Biggs, Gardnerville, NV (US)

Correspondence Address: Herbert C. Schulze, 2790 Wrondel Way, # 274, Reno, NV, 89502, US

(21) Appl. No.: 09/825,761

(22) Filed: Apr. 3, 2001

(51) Int. Cl. A01D 7/06

(52) U.S. Cl. 56/400.12

(57) ABSTRACT

This is a new rake incorporating the principles of spreading and compressing the rake tines by foot actuated lineal movement of a tine space adjustment member with the principles of an ergonomic mop handle which allows for quick conversion from a wide rake to a shovel-like member for easy conversion from raking to shoveling debris.

### BACKGROUND OF THE INVENTION

### I. FIELD OF THE INVENTION

This invention is in the general field of garden implements;

The invention is more particularly in the fields of raking and loading implements;

The invention is most particularly in the filed of implements designed to reduce strain and repetitive motion injuries caused by raking and to reduce strain and repetitive motion injuries in disposing of debris which has been raked into piles or conglomerate masses.

### II. DESCRIPTION OF THE PRIOR ART

There have been many garden rakes, and handles for rakes developed over the years. Many have been specifically designed to attempt to reduce stress and strain in raking, particularly where large areas are involved and where extensive repetitive motion is required.

Until now, there has been no real breakthrough in this field. Now, however, I have combined two known items, an adjustable rake head (the portion having a number tines which can be spread to cover a large area or condensed to provide a strengthened lifting cluster or for use in narrow confined spaces) and an ergonomic handle, previously confined to such activities as mopping. This has resulted in a surprising and unique new use for the ergonomic handle and a surprising and new use for the adjustable rake head. The result is a new instrument having unique, useful, and unanticipated uses with unexpected benefits to laborers or others engaged in gardening maintenance and the like.

I have concluded that there is no properly applicable prior art as to this new implement and method for garden maintenance.

### SUMMARY OF THE INVENTION

Gardening is one of the world's most common activities. It is engaged in by nearly all cultures in the world. Many aspects of gardening are thoroughly enjoyed by those who engage in such aspects. Some aspects of gardening are quite the contrary and are generally disliked by gardeners and the like. One of the most disliked aspects is raking debris and disposing of raked debris. In raking debris, and in disposing of raked debris, there are frequent repetitive motion injuries and strains due to the somewhat unnatural physical nature of raking to the side with a straight handled, wide-spread implement and the subsequent difficult and unnatural task of lifting debris with an implement which has an awkward and uncomfortable lifting leverage.

I have studied this problem and have analyzed all of the various instruments for raking. The most desirable raking instrument I have found is one in which the tines of the rake may be spread apart, or clustered together to take advantage of the nature of the debris and the terrains involved. This item is readily available with customary straight handles. I have discussed this rake with those who have used it. I have found that it is a very convenient implement for many purposes, but that it has many disadvantages, particularly in raking when wide-spread and for lifting and loading raked debris when clustered together. For purposes of this patent application I call this the “adjustable width rake”.

My brother and I have previously developed a unique mop handle upon which we have two patents, U.S. Utility Pat. No. 5,920,944 and Design Pat. No. D. 411,673, which I refer to as the “ergonomic mop handle”. Therefore, I began to consider whether our mop handle could be used with an adjustable width rake. At first, I determined that there was nothing compatible between our mop handle and a rake of any nature since the motions and skills involved in raking and mopping are not similar nor compatible.

After considerable work on rakes of various types, I once again turned to the ergonomic mop handle and determined to attempt to make some sort of adaptation to try to combine the advantages of the ergonomic mop handle with the advantages of the adjustable width rake.

I have now finally perfected the present invention of a unique and very useful marriage of the adjustable width rake with the ergonomic mop handle and a unique foot operated adjustment of the adjustable width rake. It is now possible, as a result of my present invention, to reduce the fatigue and repetitive motion injuries and the undue strain previously encountered by persons involved with raking and disposal of debris.

It is an object of this invention to provide a new, useful, and unique rake which will relieve strain and repetitive motion injuries for persons raking debris;

Another object of this invention is to provide such a rake which, also, is useful in disposing of debris which has been raked;

Another object of this invention is to provide such a rake which can be adjusted so as to provide an improved device for raking and disposal of debris with maximum efficiency.

The foregoing and other objects and advantages of this invention will become apparent to those skilled in the art upon reading the description of a preferred embodiment, which follows, in conjunction with a review of the appended drawings.

### BRIEF DESCRIPTION OF THE DRAWINGS

FIG. 1 is a schematic perspective of a preferred embodiment of a person holding rake which is capable of practicing the method of this invention to clear and accumulate debris;

FIG. 1A is a top elevation of the adjustment bar of this invention;

FIG. 2 is a schematic perspective of a foot operated rake tine adjustment of the area -2- on FIG. 1; and

FIG. 3 is a schematic perspective of a person using the rake of this invention to load debris into a disposal container.

### DESCRIPTION OF A PREFERRED EMBODIMENT

An inventory of items on the drawings bearing reference numerals is:

| Numeral | Item |
|---|---|
| 10 | ergonomic mop handle |
| 11 | straight portion of handle connected to rake head |
| 12 | straight portion between curves |
| 13 | curve in handle |
| 14 | upper handle grip |
| 15 | curve in handle |
| 16 | lower grip below curves |
| 17 | straight upper portion of handle |
| 20 | rake tine adjustment bar adjusting mechanism |
| 21 | adjustment rod |
| 22 | bracket |
| 23 | foot actuator |
| 24 | slotted lever arm |
| 25 | foot actuator |
| 26 | pivot pin |
| 27 | pin |
| 28 | slot |
| 29 | adjustment bar carrier rod |
| 30 | adjustment bar |
| 31 | opening for tine in adjusting bar |
| 32 | opening for tine in adjusting bar |
| 33 | opening for tine in adjusting bar |
| 34 | opening for tine in adjusting bar |
| 35 | opening for tine in adjusting bar |
| 40 | rake head and tines |
| 41 | rake tine |
| 42 | rake tine |
| 43 | rake tine |
| 44 | rake tine |
| 45 | rake tine |
| 50 | raker |
| 51 | raker hand |
| 52 | raker hand |
| 60 | trash container |
| 70 | debris |

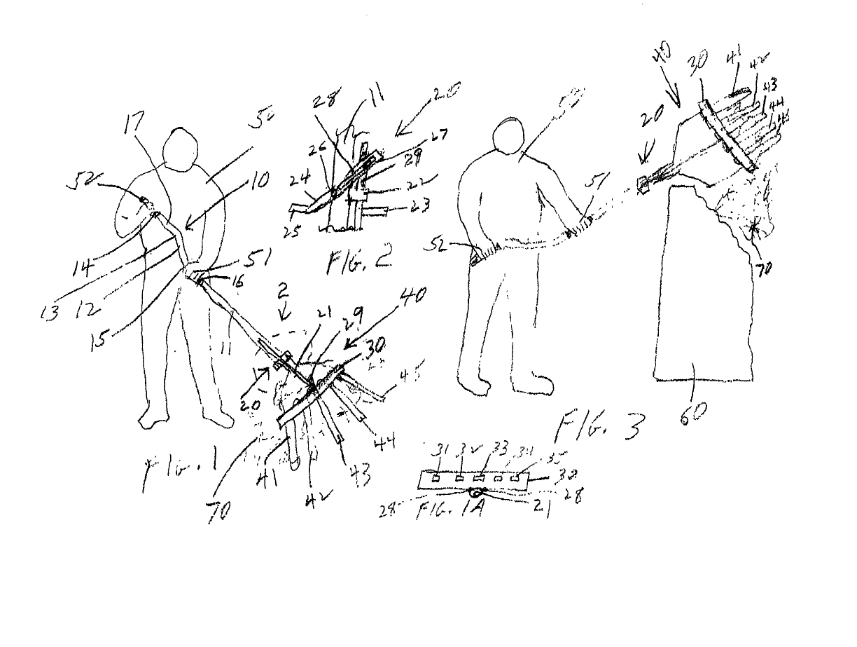

The new rake of this invention is shown in FIG. 1. A person, the raker, 50 is shown holding the implement by his right hand 52 on the rotating upper handle grip 14 and his left hand 51 on the lower rotating handle grip 16. In the position shown, and with the rake tines spread wide, the maximum effectiveness of the rake for raking purposes is achieved. In the position shown, and with the ergonomic handle, the raker can cover a much wider area with less effort than is normal for raking. This is made possible by the configuration of the straight upper handle portion 17, the handle curve 13, the intermediate straight portion 12, the handle curve 15, and the straight handle portion 11 carrying the rake head 40.

The handle 11 has a boss 22 attached as shown. Adjustment bar carrying rod 21 is mounted to boss 22 in an appropriate sliding arrangement with relation to the handle, as will be understood by those skilled in the art. The slotted lever arm is pivotally connected to the handle at 26. A pin 27 on the adjustment bar carrier rod 29 is mounted within the slot 28 in the slotted lever arm 24. A foot pedal actuator 25 is attached to, or formed integrally with, the slotted lever arm. By pressing downward on the foot pedal actuator the adjustment bar 30 will be raised (moved to the position of maximum spread of the rake tines) as will be understood by those skilled in the art.

The rake tines 41, 42, 43, 44, and 45 are caused to be spread wide as shown in FIG. 1 or closed closely together as shown in FIG. 3, or any intermediate spread as may be desired by the unique adjustment arrangement 20 shown in FIG. 2. This is accomplished by either actuating the foot actuator 23 or 25.

The rake tine adjustment bar 30 has openings 31, 32, 33, 34, and 35 for the five rake tines 41, 42, 43, 44, and 45 on the adjustable rake head 40. While five tines have been shown here, it is to be understood that the exact number of tines is not critical to the invention.

In the most preferred embodiment, as shown, the adjustment of the tines from wide spread to a compact, almost shovel-like, configuration is foot pedal actuated. The conversion from a wide rake to a shovel-like lifting implement is almost effortless.

Looking at FIG. 1 and then FIG. 3 it is clear how simple the operation is now. By using a foot in the position of FIG. 1, where a pile of raked debris 70 is under the rake tines 41, 42, 43, 44, and 45, the tines are brought together as shown in FIG. 3 and are thus able to support the pile of debris 70 and transfer it easily to the trash container 60. Without this unique combination it would have been necessary for the raker to have raked the debris with a rake. Then he would have been required to obtain another implement such as a shovel or the like to transfer the debris to a trash container or the like.

In the claims which follow if I should fail to claim some patentable feature of this invention it will be due to unintentional omission, and not through a desire to dedicate or abandon the feature.

While the embodiments of this invention shown and described are fully capable of achieving the objects and advantages desired, it is to be understood that such embodiments are for purposes of illustration and not for purposes of limitation.

I claim:

1. A combination adjustable implement comprising: an ergonomic handle comprising an elongate tubular member having a first upper straight portion, a first upper curve, a second intermediate straight portion, a second lower curve, and a third straight portion; a rake head comprising a multiplicity of adjustable rake tines attached to said third straight portion; a rake tine adjustment member moveably mounted on said adjustable rake tines; and means to move the adjustment member in such manner is to spread said rake tines or to gather said rake tines into a compressed area.

2. The implement of claim 1 wherein the rake tine adjustment is foot acuated.
